(19) United States
(12) Patent Application Publication
(10) Pub. No.: US 2011/0033234 A1
(43) Pub. Date: Feb. 10, 2011

(54) POWER TAKE-OFF COUPLING

(76) Inventor: Edward Charles Mendler, Mill Valley, CA (US)

Correspondence Address: Charles Mendler, 7 Millside Lane, Mill Valley, CA, 94941, US

(21) Appl. No.: 12/735,770

(22) PCT Filed: Mar. 18, 2008
(86) PCT No.: PCT/US2008/003585

§ 371 Date: Aug. 12, 2010

Related U.S. Application Data
(60) Provisional application No. 60/920,799, filed on Mar. 28, 2007.

(51) Int. Cl. F16D 3/04

(52) U.S. Cl. 404/102

(57) ABSTRACT

According to the present invention, a variable compression ratio engine having crankshaft main bearings mounted in one or more eccentrics includes a power take-off coupling having a single link or linkage. In the preferred embodiment of the present invention a drive arm is integrated into the crankshaft and a driven arm is integrated into the torque converter or clutch housing. The power take-off coupling further has a linkage having a first linkage end and a second linkage end. The first linkage end is pivotally connected to the drive arm and the second linkage end is pivotally connected to the driven arm for transferring torque from the crankshaft to the torque converter or clutch housing. According to the preferred embodiment of the present invention, the power take-off coupling has only one link. The link, drive arm and driven arm are all rigid components made out of steel or other suitably stiff and strong metal. The single link is exceptionally robust, reliable and simple. The axels for the linkage are generally larger in diameter than piston pins, and can withstand engine detonation forces as well as other cranktrain bearings can, such as the piston pins, connecting rod big end bearings and crankshaft main bearings. The power take-off coupling of the present invention has a low cost and is easy to assemble. A further advantage of the present invention is the small magnitude of its friction penalty. Engines that are currently mated to torque converters will require only one new bearing to support the output shaft of the present invention. The one new bearing contributes relatively little to over-all engine friction losses. The linkage axel bearings pivot only a few degrees back and forth, and do not substantively increase engine friction losses. Another advantage of the present invention is its short axial length. The short axial length is highly desirable for packaging of the variable compression ratio engine in the small engine bays commonly found in passenger cars. The power take-off coupling of the present invention is robust and reliable, can withstand detonation forces to the same degree as other cranktrain components, has very low friction losses, has a short axial length, is easy to assemble, and has a low cost .

This application relates to Provisional Application No. 60/920,799 having a filing date of Mar. 28, 2007.

### BACKGROUND OF THE INVENTION

Variable compression ratio can significantly increase the fuel efficiency of reciprocating piston engines used in passenger cars and trucks. The present invention relates to a variable compression ratio mechanism having a crankshaft mounted in eccentric supports, and more specifically to the power take-off coupling for connecting the crankshaft to the transmission. Engines of this type have a crankshaft axis of rotation that changes in location with adjustment of compression ratio. Consequently, a power take-off coupling is needed to accommodate the misalignment of the crankshaft and transmission input shaft.

Gear drives have been used to accommodate misalignment of the crankshaft and transmission shaft in variable compression ratio engines having a crankshaft mounted in eccentrics. Gear drives are shown by Roozenboom of Caterpillar Inc. in U.S. Pat. No. 7,185,616 ; Lawrence et al. of Caterpillar Inc. in U.S. Patent Application 2006/0112911 A1; Barradine in International Publication No. WO 2007/081222 A1; Schmied in U.S. Pat. No. 7,150,259 B2; Mendler (the present applicant, with certain rights assigned to the US Government) in US Patent Nos. 6,637,384 B1, 6,443,107 B1, and 6,260,532 B1; Yapici of FEV in U.S. Pat. No. 6,247,430 B1; German Patent No. DE 297 19 343 U1; German Patent No. DE 198 41 381 A1; Matesic in French Patent EP 0560 701 A1; Johnson in U.S. Pat. No. 4,738,230; Schmid in German Patent No. DE 3644721 A1; Dr. Hermann Hiereth of Daimler-Benz in German Patent No. DE 30 04 402 A1; and Chapman in U.S. Pat. No. 936,409 awarded Oct. 12, 1909. A problem with gear drives is that engine detonation or knocking results in very high loading on the gear teeth, resulting in damage of the gear teeth and accelerated aging. Engine manufacturers design engines to not have detonation, however in practice detonation can be expected to occur occasionally due to poor fuel quality, use of a fuel having an octane rating below the value specified by the engine manufacturer, high temperatures, inadequate maintenance, and/or other factors. Consequently, the power take-off coupling must accommodate at a minimum infrequent detonation. Gear drives can be oversized in design and also built to higher quality standards to accommodate occasional detonation, however, these gear drives are costly, heavy, and increases engine size. Another problem with gear drives is that they tend to be noisy.

Yapici et al. of FEV show a power take-off coupling in International Publication No. WO 00/77368 A1. The new approach provides an alternative to his earlier gear drive power take-off coupling shown in U.S. Pat. No. 6,247,430 B1 (referenced above). A similar arrangement is shown by Pischinger et al. also of FEV in U.S. Pat. No. 6,443,106 B1 having at least two crank elements 19 shown in FIG. 3 of the patent. Power take-off couplings of this type are relatively complex, and have been found to have substantive internal friction losses. Additional problems with the coupling include cost, difficulty of assembly, and life cycle durability.

Yapici shows a power take-off coupling in International Publication No. WO 2007/115562 A2 published Oct. 18, 2007 having a spring system similar in design to a torsional vibration damper or dual-mass flywheel. The new approach provides an alternative to his earlier power take-off couplings shown in WO 00/77368 A1 and U.S. Pat. No. 6,247,430 B1 (referenced above). The new approach is complex. The mechanical capabilities and cost of the system are not publicly known at this time.

Goransson et al. of SAAB show a power take-off coupling in U.S. Pat. No. 7,213,545 B2 issued on May 8, 2007 having an internal U-joint or Hooke's type assembly. Development work on this same concept a number of years ago by the present applicant showed that the U-joint is generally too small in size to accommodate high torque levels and/or detonation loading.

A Schmidt offset coupling is shown in Machine Design by Robert L. Norton, Published in 1996 by Prentice-Hall, page 629. The Schmidt coupling includes six links and three linkage disks. Problems with the Schmidt coupling include too large a size for automotive use, reliability and durability under engine detonation conditions, engine assembly, and cost.

A simple, low cost, highly durable and highly reliable power take-off coupling is needed for variable compression ratio engines of the type having a crankshaft mounted in eccentric supports. In particular, a power take-off coupling is needed that can withstand detonation and abuse generally to the same degree as the crankshaft and other cranktrain components. The power take-off coupling needs to be easy to assemble, and compact in size and not overly heavy.

### SUMMARY OF THE INVENTION

According to the present invention, a variable compression ratio engine having crankshaft main bearings mounted in one or more eccentrics includes a power take-off coupling having a single link or linkage. In the preferred embodiment of the present invention a drive arm is integrated into the crankshaft and a driven arm is integrated into the torque converter or clutch housing. The power take-off coupling further has a linkage having a first linkage end and a second linkage end. The first linkage end is pivotally connected to the drive arm and the second linkage end is pivotally connected to the driven arm for transferring torque from the crankshaft to the torque converter or clutch housing. According to the preferred embodiment of the present invention, the power take-off coupling has only one link. The link, drive arm and driven arm are all rigid components made out of steel, iron or other suitably stiff and strong metal.

The location of the crankshaft rotational axis is adjustable relative to the torque converter rotational axis for adjusting the compression ratio of the variable compression ratio engine during running operation of the variable compression ratio engine. In more detail, the location of the crankshaft rotational axis can be adjusted after the engine is fully assembled, and while the engine is running and generating power.

The single link is exceptionally robust, reliable and simple. The axels for the linkage are generally larger in diameter than piston pins, and can withstand engine detonation forces as well as other cranktrain bearings can, such as the piston pins, connecting rod big end bearings and crankshaft main bearings. The power take-off coupling of the present invention has a low cost and is easy to assemble.

A further advantage of the present invention is the small magnitude of its friction penalty. Engines that are currently mated to torque converters will require only one new bearing to support the output shaft of the present invention. The one new bearing contributes relatively little to over-all engine friction losses. The linkage axel bearings pivot only a few degrees back and forth, and do not substantively increase engine friction losses. Another advantage of the present invention is its short axial length. The short axial length is highly desirable for packaging of the variable compression ratio engine in the small engine bays commonly found in passenger cars.

The power take-off coupling of the present invention is robust and reliable, can withstand detonation forces to the same degree as other cranktrain components, has very low friction losses, has a short axial length, is easy to assemble, and has a low cost.

### BRIEF DESCRIPTION OF THE DRAWINGS

FIG. 1 is intended to illustrate a variable compression ratio engine having a power take-off coupling according to the present invention.

FIG. 2 is a front view of FIG. 1.

FIG. 3 is a detailed view of a portion of FIG. 2, and is intended to illustrate pivoting of the variable compression ratio eccentrics.

FIG. 4 is similar to FIG. 1 but shows an optional linkage.

FIG. 5 is intended to illustrate the linkage axels.

FIG. 6 is similar to FIG. 5, but shows linkage axels cantilevered in opposite directions.

FIG. 7 is intended to illustrate an optional balancing arrangement for the present invention.

FIG. 8 is intended to illustrate the present invention with the output shaft including a torque converter.

FIG. 9 is a section view of the power take-off coupling according to the present invention.

FIG. 10 is similar to FIG. 9 but shows an interference fit between the driven arm and hub mount.

FIG. 11 is similar to FIG. 9 but shows the driven arm attached to the hub mount with fasteners.

FIG. 12 is intended to illustrate an output shaft supported by one or more roller bearings.

### DETAILED DESCRIPTION OF THE PREFERRED EMBODIMENTS

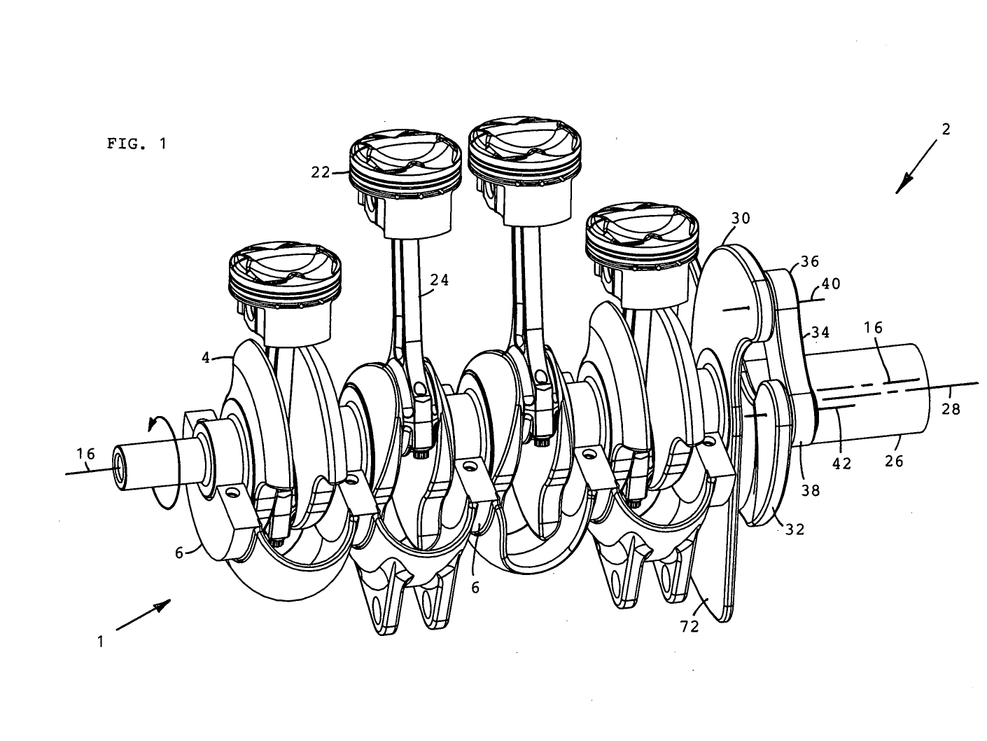

FIGS. 1, 2 and 3 are partial views that are intended to illustrate a variable compression ratio engine 1 having a power take-off coupling 2 according to the present invention. Variable compression ratio engine 1 is partially disassembled in order to provide an unobstructed view of the power take-off coupling. In more detail, the crankcase, cylinder head and other selected components of the engine are not shown.

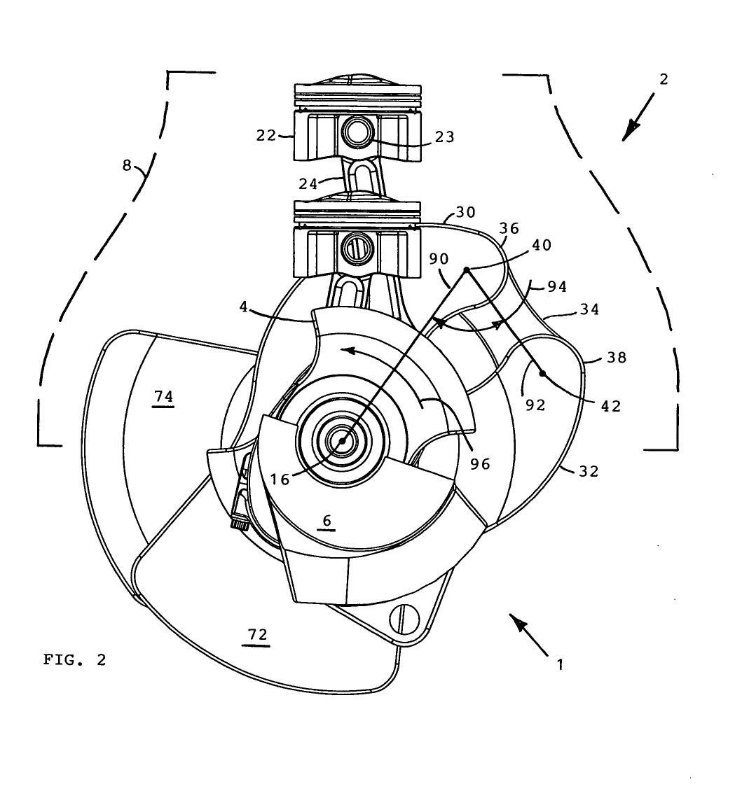

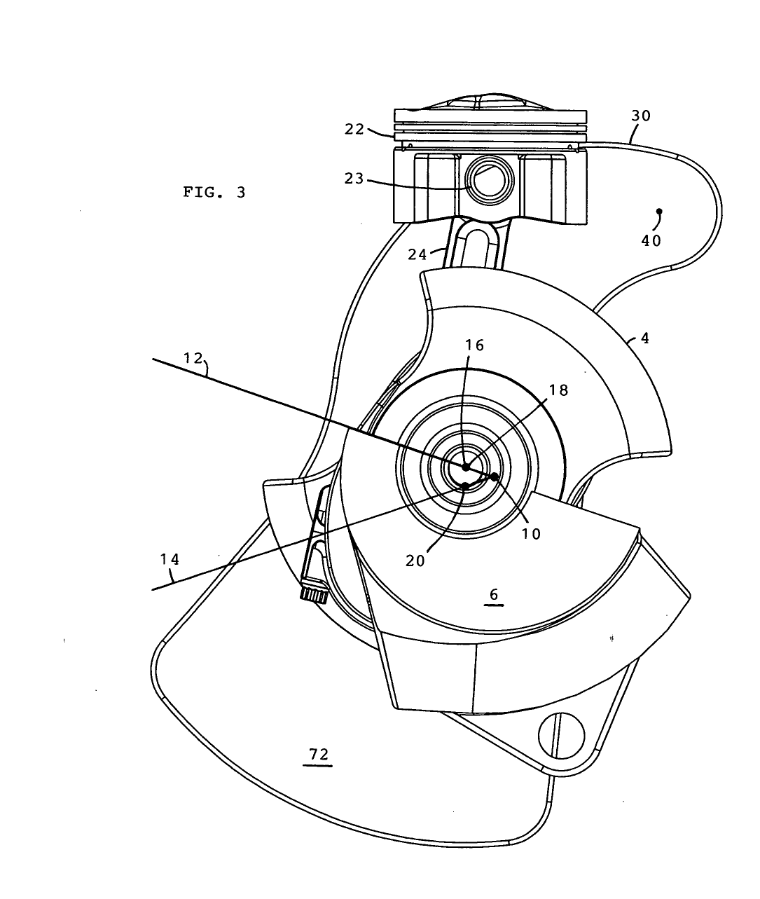

A crankshaft 4 is mounted in one or more eccentrics 6. Eccentrics 6 are mounted in a crankcase 8, which is schematically illustrated in FIG. 2 with dashed lines. The bearing caps used for retain crankshaft 4 in eccentrics 6 are not shown in order to provide a clear view of the crankshaft. Eccentric 6 has a pivot axis 10, a high compression ratio alignment angle 12, and a low compression ratio alignment angle 14 (shown in FIG. 3). Crankshaft 4 defines a first axis of rotation 16 about which crankshaft 4 rotates. Crankshaft 4 has a first crankshaft location 18, first crankshaft axis location 18 being in effect when eccentric 6 is positioned along alignment angle 12 (shown). Crankshaft 4 has a second crankshaft axis location 20, second crankshaft location 20 being in effect when eccentric 6 is positioned along alignment angle 14. FIG. 3 illustrates a high compression ratio setting for variable compression ratio engine 1, where eccentric 6 is positioned on high compression ratio alignment angle 12, and where first axis of rotation 16 is generally concentric with first crankshaft axis location 18.

Pivoting of eccentrics 6 in variable compression ratio engine 1 from high compression ratio alignment angle 12 to low compression ratio alignment angle 14 lowers the position of crankshaft 4 and lowers the position of first axis of rotation 16, and thereby lowers the compression ratio of variable compression ratio of engine 1.

Variable compression ratio engine 1 further includes one or more pistons 22 each having a piston pin 23 and one or more connecting rods 24 for connecting pistons 22 to crankshaft 4.

Variable compression ratio engine 1 further includes an output shaft 26. Output shaft 26 defines a second axis of rotation 28 about which output shaft 26 rotates. Output shaft 26 is used to transfer power to a transmission or other driven device such as a generator or propeller.

Pivoting of eccentrics 6 in variable compression ratio engine 1 from high compression ratio alignment angle 12 to low compression ratio alignment angle 14 adjusts the location of first axis of rotation 16 relative to second axis of rotation 28. Accordingly, crankshaft 4 cannot be directly attached to output shaft 26. The present invention provides a power take-off coupling for transferring power and torque from crankshaft 4 to output shaft 26 that permits adjustment of the location of first axis of rotation 16 relative to second axis of rotation 28.

Referring now to FIG. 1, first axis of rotation 16 has a location relative to second axis of rotation 28. Under at least one compression ratio setting of variable compression ratio engine 1, first axis of rotation 16 is spaced apart from second axis of rotation 28. The location of first axis of rotation 16 is adjustable relative to second axis of rotation 28 for adjusting the compression ratio of variable compression ratio engine 1 during running operation of the variable compression ratio engine. In more detail, the location of first axis of rotation 16 can be adjusted after the engine is fully assembled, and while the engine is running and generating power. Preferably first axis of rotation 16 and second axis of rotation 28 are parallel.

According to the present invention, crankshaft 4 further has a drive arm 30 and output shaft 26 has a driven arm 32, and a linkage 34. Linkage 34 has a first linkage end 36 and a second linkage end 38. First linkage end 36 is pivotally connected to drive arm 30, and second linkage end 38 is pivotally connected to driven arm 32, for rotatably coupling crankshaft 4 and output shaft 26 for transferring torque from crankshaft 4 to output shaft 26.

In more detail, according to the preferred embodiment of the present invention, power take-off coupling 2 for variable compression ratio engine 1 includes a crankshaft 4, and crankshaft 4 defines a first axis of rotation 16 about which crankshaft 4 rotates. Variable compression ratio engine 1 also includes an output shaft 26, and output shaft 26 defines a second axis of rotation 28 about which output shaft 26 rotates. Preferably first axis of rotation 16 is generally parallel to second axis of rotation 28. First axis of rotation 16 further has a location relative to second axis of rotation 28, where the location of first axis of rotation 16 is adjustable relative to second axis of rotation 28 for adjusting the compression ratio of the variable compression ratio engine 1 during running operation of the engine. Crankshaft 4 further has a drive arm 30 and output shaft 26 further has a driven arm 32. Power output coupling 2 further has a linkage 34, linkage 34 further having a first linkage end 36 and a second linkage end 38. First linkage end 36 is pivotally connected to drive arm 30, and second linkage end 38 is pivotally connected to driven arm 32 for rotatably coupling crankshaft 4 and output shaft 26 for transferring torque from crankshaft 4 to output shaft 26.

Referring now to FIGS. 1 and 2, preferably power output coupling 2 further includes a first linkage axis 40, and a second linkage axis 42. Preferably first linkage end 36 is pivotally connected to drive arm 30 on first linkage axis 40, and second linkage end 38 is pivotally connected to driven arm 32 on second linkage axis 42.

Preferably, according to the present invention, linkage 34 is generally rigid for providing a generally fixed spacing between first linkage end 36 and second linkage end 38. Preferably linkage 34 is rigid for providing a generally fixed spacing between drive arm 30 and driven arm 32. Preferably linkage 34 is rigid for providing a generally fixed spacing between first linkage axis 40 and second linkage axis 42.

Linkage 34 is preferably a single cast and/or machined rigid metal part. Bearings may optionally be assembled onto the linkage, such as bushing inserts or roller bearings.

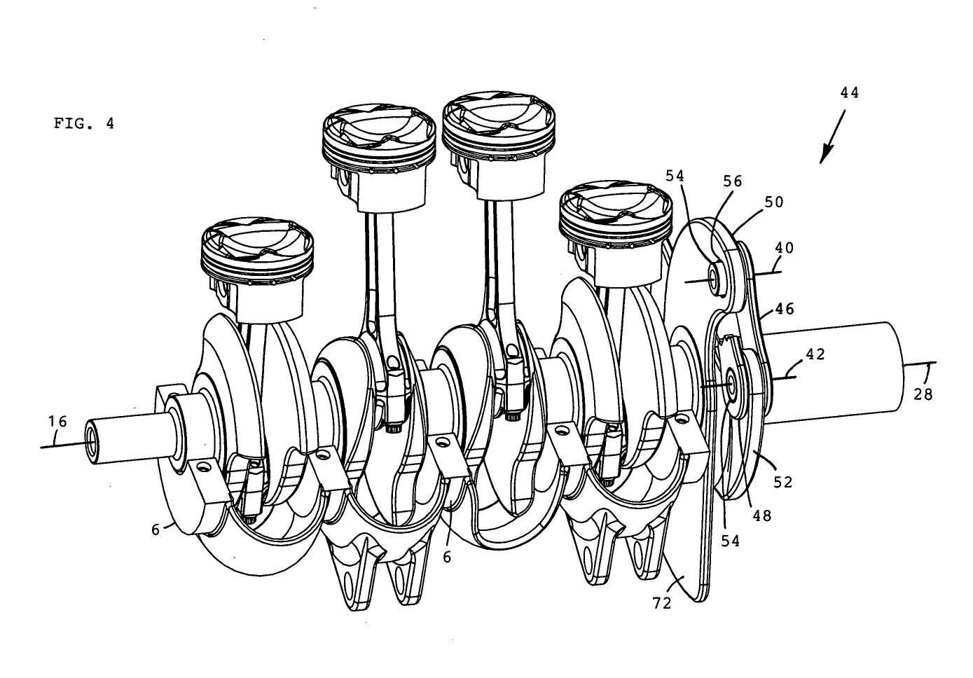

FIG. 4 shows a linkage 44. Optionally the linkage may include an assembly of parts. Linkage 44 includes a plurality of links, and in more detail a first link 46 and a second link 48. Second link 48 is shown partially cut away. In more detail the power take off coupling of the present invention may optionally include a drive arm with one or more axel holes 50, a driven arm with one or more axel holes 52, and one or more axels 54. An axel hole 56 is shown in the drive arm with one or more axel holes 50. Linkage 44 is similar to linkage 34 (shown in FIG. 1) in that both linkages provide a generally fixed spacing between first linkage axis 40 and second linkage axis 42. Preferably, according to the present invention, the component parts of the linkage have a relatively fixed location relative to one another. For example, first link 46 has a generally fixed location relative to second link 48. Preferably, according to the present invention power take-off coupling 2 includes no more than one linkage. The linkage, however may include an assembly of parts as just described.

Optionally, axels 54 may be press fit into drive arm with an axel hole 50 and/or driven arm with an axel hole 52. Accordingly, link 46 pivots on axels 54, and link 48 pivots on axels 54. According to the present invention, link 46 and link 48 are defined as a single linkage. In more detail, links that share a first linkage axis 40 and a second linkage axis 42 are defined as a single linkage according to the present invention.

Referring now to FIG. 2, a first imaginary line 90 spans between first axis of rotation 16 and first linkage axis 40, and a second imaginary line 92 spans between first linkage axis 40 and second linkage axis 42. The power takeoff coupling further has a linkage angle 94, linkage angle 94 being defined as the angle between first imaginary line 90 and second imaginary line 92. Arrow 96 is intended to indicate rotation of crankshaft 4 about first axis of rotation 16. Linkage angle 94 changes in magnitude during rotation of crankshaft 4 about first axis of rotation 16. Preferably, according to the present invention, linkage angle 94 changes in magnitude by no more than plus or minus 12 degrees during one full rotation of crankshaft 4 about first axis of rotation 16, thereby providing a rotational velocity of output shaft 26 that closely aligns with the rotational velocity of crankshaft 4, and having a small variation in output shaft rotational velocity.

A further advantage of the present invention is the small magnitude of its friction penalty. Engines that are currently mated to torque converters will require only one new bearing to support the output shaft of the present invention as will be described later on. The one new bearing contributes relatively little to over-all engine friction losses. The linkage axel bearings typically pivot less than 12 degrees back and forth, and do not substantively increase engine friction losses.

Referring again to FIG. 2, optionally linkage 34 may include spherical or ball joints at first linkage end 36 and/or second linkage end 38. In embodiments of the present invention having spherical or ball joints, the pivot point for first linkage end 36 is generally located on first linkage axis 40, and the pivot point for second linkage end 38 is generally located on second linkage axis 42. A spherical joint, ball joint and other forms of joints enabling pivoting on more than one axis are referred to generally as spherical joints.

Referring now to FIG. 1, preferably drive arm 30 is rigid, and preferably drive arm 30 is rigidly attached to crankshaft 4.

FIG. 1 shows drive arm 30 formed in crankshaft 4. In more detail, drive arm 30 may optionally be an integral part of the crankshaft (shown). Optionally drive arm 30 may be part of the crankshaft casting, forging, and/or machined crankshaft part.

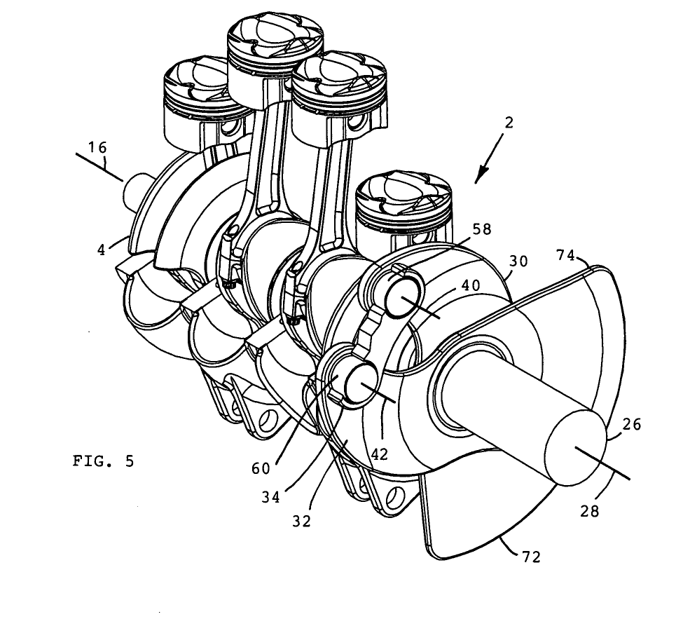

Referring not to FIG. 5, preferably driven arm 32 is rigid, and preferably driven arm 32 is rigidly attached to output shaft 26. In more detail, driven arm 32 may optionally be an integral part of the output shaft (shown), or optionally assembled onto the output shaft.

FIG. 5 is similar to FIG. 1, but shows link 34 partially cut away to show a first linkage axel 58 on drive arm 30. First linkage axel 58 is located on first linkage axis 40.

First linkage axel 58 is preferably cantilevered off of drive arm 30, thereby permitting linkage 34 to slide onto the free end of first linkage axel 58 during assembly.

First linkage axel 58 is preferably formed directly on said crankshaft 4. In more detail, preferably drive arm 30 and first axel 58 are formed directly in crankshaft 4, and preferably crankshaft 4 and first axel 58 are a single metal part, thereby providing a rigid low-cost structure. First axel 58 preferably is machined out of the crankshaft casting, forging or billet. FIG. 5 shows a second linkage axel 60 on driven arm 32. Preferably second linkage axel 60 and driven arm 32 are a single metal part.

Preferably second linkage axel 60 is cantilevered off of driven arm 32, thereby permitting linkage 34 to slide onto the free end of second linkage axel 60 during assembly. Preferably first linkage axel 58 and second linkage axel 60 are cantilevered in the same direction, thereby permitting linkage 34 to slide onto first linkage axel 58 and second linkage axel 60 during assembly. Preferably linkage 34 can slide onto first and second linkage axels 58 and 60 respectively at the same time. Preferably linkage 34 has straight or generally flat link elements to avoid twisting of the linkage under loading.

Preferably, according to the present invention, linkage 34 has female bearing sockets at both ends and the drive arm and driven arm have male bearing axels, thereby providing more uniform loading along the axial length of the linkage axels 58 and 60.

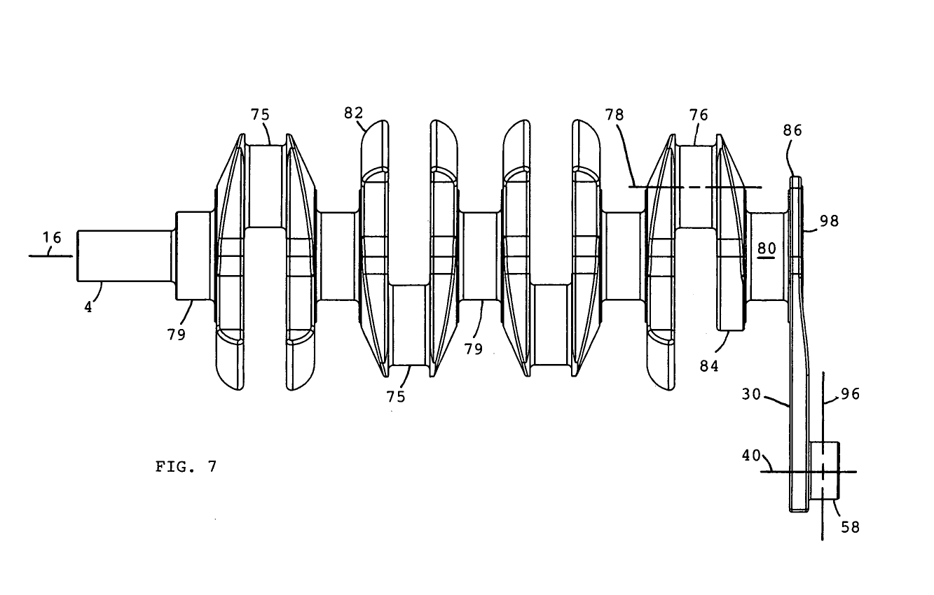

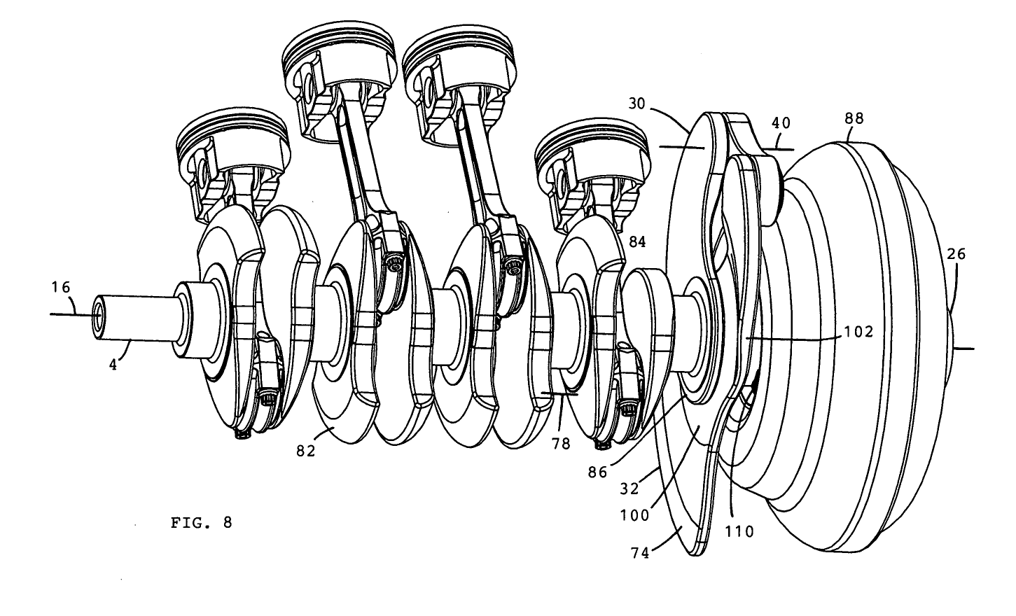

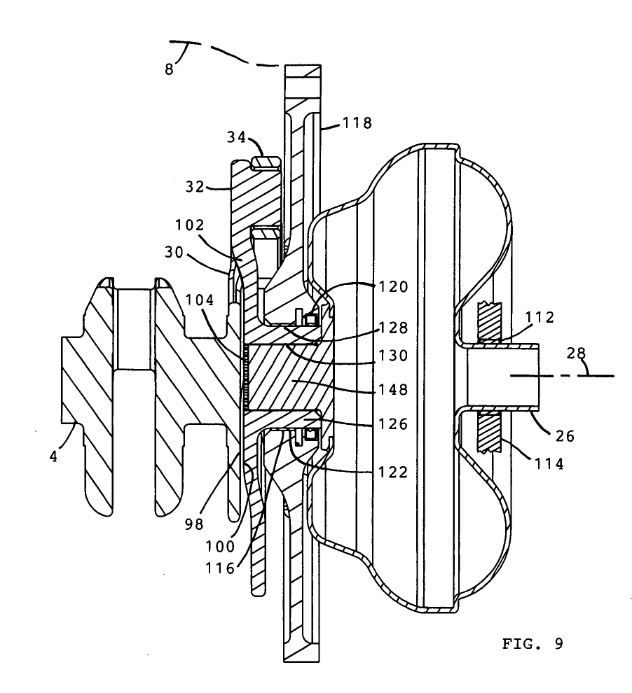

Referring now to FIGS. 1, 5, 7, 8, and 9, according to the present invention first linkage axel 58 and second linkage axel 60 are preferably centered generally on the same radial plane 96 (illustrated in FIGS. 5 and 7), and preferably linkage 34 is also centered or located generally on the same radial plane 96. Drive arm 30 includes a drive hub region 98, and driven arm 32 includes a driven hub region 100 (illustrated in FIGS. 7, 8 and 9). Referring now to FIGS. 8 and 9, according to the present invention driven arm 32 preferably includes a bend 102, for providing first linkage axel 58 and second linkage axel 60, and/or a linkage 34 centered or located generally on the same radial plane 96 while also preventing mechanical interference of drive arm hub region 98 and driven arm hub region 100.

Optionally, according to the present invention drive arm 30 may include a bend similar to bend 102 for providing first linkage axel 58 and second linkage axel 60, and/or a linkage 34 centered or located generally on the same radial plane 96 while also preventing mechanical interference of drive arm hub region 98 and driven arm hub region 100.

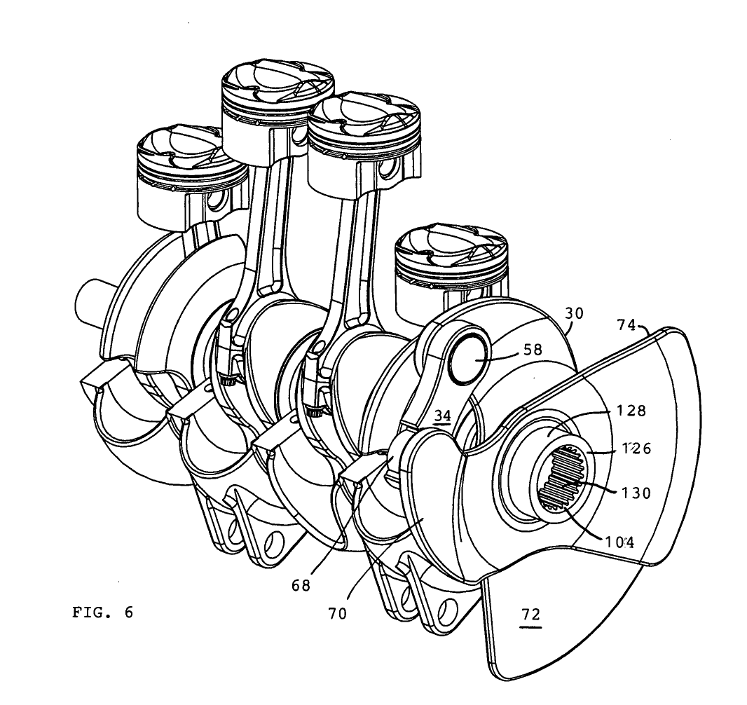

FIG. 6 is similar to FIG. 1, but shows an optional second linkage axel 68 and a driven arm 70. Second linkage axel 68 is cantilevered off of driven arm 70, thereby permitting linkage 34 to slide onto the free end of second linkage axel 68 during assembly. Linkage 34 is shown partially cut away in order to show second linkage axel 68. First linkage axel 58 can be seen extending from drive arm 30. Optionally first linkage axel 58 is cantilevered off of drive arm 30 in a first direction, and second linkage axel 68 is cantilevered off of driven arm 70 in the opposite direction of the first direction, and in more detail the two linkage axels are cantilevered in opposite directions, thereby retaining linkage 34 in place after assembly.

Referring again to FIG. 4, the drive arm may optionally include one or more holes 56 for retaining an axel. Similarly, the driven arm may optionally include one or more holes for retaining an axel. Optionally, links 46 and 48 may be press fit onto axels 54, for retaining linkage 44 on drive arm with an axel hole 50 and/or on driven arm with an axel hole 52. In this embodiment of the present invention axels 54 are free to pivot in axel holes 56. Optionally, one or more links may be rigidly joined to the axel, and the axel pivotally supported in the driven arm.

Referring now to FIGS. 1 through 6, power take-off coupling 2 preferably includes at least one balance weight for balancing the centrifugal force of the linkage assembly. Preferably one or more balance weights 72 are placed on the drive arm, and one or more balance weights 74 are placed on the driven arm to provide improved balancing of the rotating components, such as the linkage, drive and driven arms, axels and/or other rotating components of the power take-off coupling.

FIGS. 7 and 8 are intended to illustrate crankshaft 4 having an optional balancing embodiment of the present invention. Crankshaft 4 has one or more connecting rod big end bearings or journals 75 and an end connecting rod big end bearing or journal 76, end connecting rod journal 76 being located generally adjacent to drive arm 30, or generally at the end of the crankshaft adjacent to the power take-off coupling. End connecting rod journal 76 is centered on an end connecting rod axis 78. Crankshaft 4 further includes a plurality of crankshaft main bearings or journals 79 and an end main bearing or journal 80, end main bearing 80 being located between end connecting rod journal 76 and drive arm 30. Crankshaft 4 further includes one or more balancing weights 82. Optionally drive arm 30 and/or first linkage axel 58 may be positioned generally opposite to connecting rod axis 78 for counterbalancing in part the centrifugal forces associated with connecting rod journal 76, and an undersized balancing weight 84 may be used between connecting rod journal 76 and drive arm 30. Preferably first linkage axel 58 is located about 180 degrees from connecting rod axis 78, with the 180 degrees measured around the first axis of rotation 16. The term opposite is intended to indicate about 180 degrees around the first axis of rotation 16. The position of first linkage axel 58 is typically not exactly opposite connecting rod axis 78, instead, it is preferable that first linkage axis 58 is positioned for counterbalancing the connecting rod journal and/or minimizing loading on end main bearing 80 and for minimizing the balancing mass needed for providing a balanced cranktrain.

Optionally, balance weight 72 (shown in FIGS. 1 through 6) may be replaced with an undersized balance weight 86. According to the present invention, the drive arm 30 and linkage axel 58 are preferably positioned generally opposite to end connecting rod journal 76, for counterbalancing the centrifugal force associated with end connecting rod journal 76 and minimizing the rotational mass by reducing balance weight size. In general an undersized balance weight 84 may be used on the crankshaft, and/or an undersized balancing weight 86 used on the drive arm to reduce overall rotational mass and overall rotational inertia.

FIG. 8 shows a torque converter 88. Optionally (not shown) balance weight 74 may be incorporated into the torque converter 88, clutch, clutch housing or other rotating components of the output shaft. According to the present invention, output shaft 26 may optionally include a torque converter (shown), a flywheel and/or a clutch (not shown).

Referring now to FIGS. 1, 6 and 9, output shaft 26 may be a single part as shown in FIG. 1, or an assembly of parts as shown in FIGS. 6 and 9. Referring now to FIGS. 6 and 9, driven arm 32 or 70 may optionally include a spline 104 (shown) or a key. According to the present invention, driven arm 32 or 70 is optionally joined to torque converter 88 with spline 104, thereby forming output shaft 26. Spline 104 may optionally be used to form an assembled output shaft not having a torque converter. Optionally, spline 104 may be used to assemble an output shaft for engines having manual or automated manual transmissions that do not have torque converters.

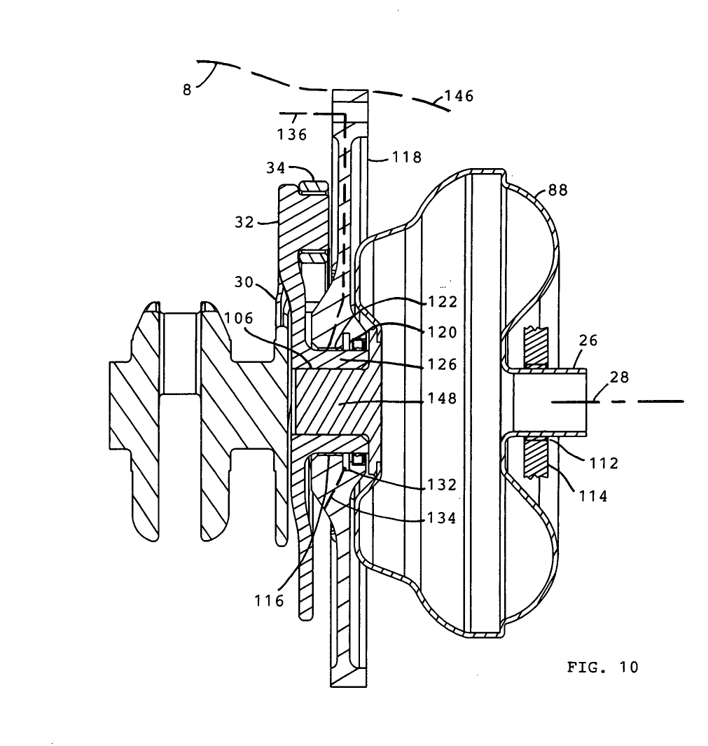

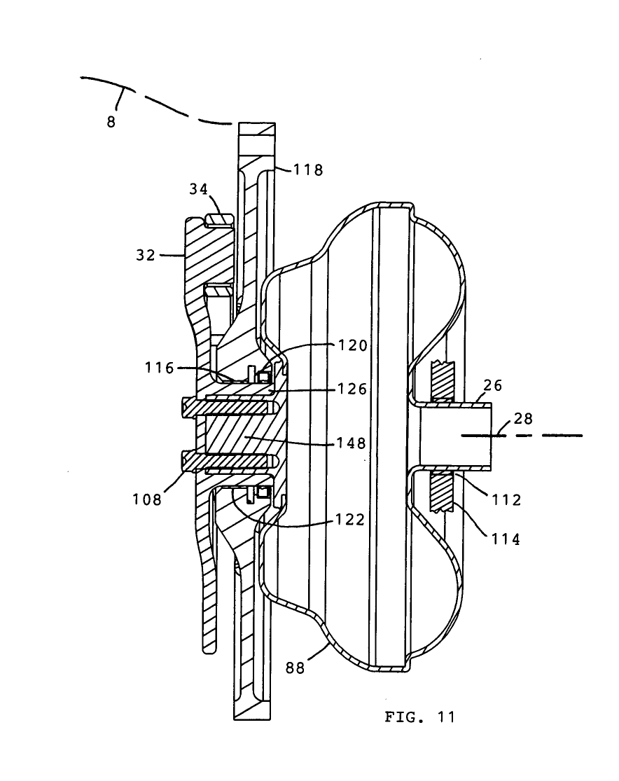

Referring now to FIG. 10, a press fit, shrink fir or other type of interference fit 106 may optionally be used to join driven arm 32 to torque converter 88 and/or otherwise assemble an output shaft. Referring now to FIG. 11, one or more fasteners 108 may optionally be used to join driven arm 32 to torque converter 88 and/or otherwise assemble an output shaft. Referring now to FIG. 8, a weld 110 may optionally be used to join driven arm 32 to torque converter 88 and/or otherwise assemble an output shaft. Preferably, according to the present invention, the output shaft is a rigid stiff structure, whether the output shaft is assembled or not. Preferably the driven arm is removably assembled to the output shaft assembly, however disassembly is not practical in some embodiments of the present invention.

According to the present invention, the output shaft may optionally be assembled, and the driven arm may optionally be attached to the output shaft assembly with an attachment means selected form the following group: a spline, a press fit, a shrink fit, an interference fit, a key, a weld, or one or more fasteners. A press fit and a shrink fit are both interference fits, and may be referred to generally as interference fits.

According to the present invention, the drive arm may optionally be assembled onto the crankshaft using similar attachment means as shown for attaching the driven arm to the output shaft. In more detail, the drive arm may optionally be attached to the crankshaft with an attachment means selected form the following group: a spline, a press fit, a shrink fit, an interference fit, a key, a weld, or one or more fasteners.

Referring now to the embodiments of the present invention shown in FIGS. 9, 10 and 11, the power take-off coupling has a first bearing 112 for rotatably supporting output shaft 26 on second axis of rotation 28, and a first bearing support 114 for supporting first bearing 112. First bearing support 114 has a generally fixed location relative to crankcase 8, shown in dashed lines in FIGS. 2, 9, 10 and 11. The power take-off coupling further has a second bearing 116 for rotatably supporting output shaft 26, and a second bearing support 118 for supporting second bearing 116. Second bearing support 118 also has a generally fixed location relative to crankcase 8, shown in dashed lines in FIGS. 2, 9, 10 and 11. Second bearing support 118 also has a generally fixed location relative to first bearing support 114. Preferably, according to the present invention, second bearing support 118 is located generally between torque converter 88 and linkage 34.

Optionally, according to the present invention, first bearing 112 may be located in the transmission oil pump, and/or first bearing support 114 may optionally be an oil pump housing. Accordingly, in embodiments of the present invention that employ an existing oil pump bearing, only one new bearing is generally required to support the output shaft of the present invention.

The power take-off coupling optionally includes an oil seal 120 for preventing oil from second bearing 116 from escaping to the torque converter side of second bearing support 118. Preferably, second bearing support 118 further retains the engine oil inside crankcase 8. Preferably oil seal 120 is located between second bearing 116 and torque converter 88.

Preferably, according to the present invention, the power take-off coupling has a first bearing 112 for rotatably supporting output shaft 26 on second axis of rotation 28, and a first bearing support 114 for supporting first bearing 112. First bearing support 114 has a generally fixed location relative to crankcase 8 and in general the variable compression ratio engine. The power take-off coupling has a second bearing 116 for rotatably supporting output shaft 26, and a second bearing support 118 for supporting second bearing 116. Second bearing support 118 has a generally fixed location relative to first bearing support 114. Preferably second bearing support 118 has a central bearing socket 122, central bearing socket 122 being non-separable. Driven arm 32 is attached to the output shaft assembly 26 through central bearing socket 122.

Referring now to FIGS. 6 and 9, preferably, according to the present invention, driven arms 32 and 70 have a hub 126 having a hub outer surface 128, hub outer surface 128 providing the bearing journal surface for second bearing 116. Hub outer surface preferably also provides the bearing surface for oil seal 120. Hub 126 further has a hub interior 130. Preferably, according to the present invention the fixture element, such as a spline (shown), a press-fit, a shrink fit, interference fit or a key engages the hub interior 130.

Referring now to FIG. 10, second bearing support 118 optionally includes an oil drain groove 132 and/or an oil drain passageway 134 (schematically illustrated by a dashed line) for draining oil from second bearing 116. Preferably oil drain groove 132 and/or oil drain passageway 134 direct the drainage oil towards crankcase 8, and in more detail towards the side of the second bearing support adjacent to linkage 34. An oil feed galley is schematically illustrated by dashed line 136. Oil feed galley 136 preferably feeds oil to second bearing 116. Dashed line 146 is intended to illustrate a transmission or bellhousing rigidly attached to second bearing support 118.

Preferably torque converter 88 (or another portion of output shaft 26, and in particular for embodiments of the present invention not having torque converters) includes a hub mount 148. Preferably hub mount 148 is rigidly attached to torque converter 88 or another portion of output shaft 26. Hub mount 148 may be welded to torque converter 88, or be formed out of the torque converter metal stamping, or fastened to the torque converter or output shaft by other means. Alternatively hub mount 148 may be machined directly onto torque converter 88 or another portion of output shaft 26. Preferably hub mount 148 is located coaxially inside of hub 126. In more detail, preferably hub interior 130 is rigidly attached to hub mount 148, and second bearing 116 runs on hub outer surface 128, hub mount 148 being located coaxially and inside hub 126 and inside hub outer surface 128, for providing a short over all axial length for the power take-off coupling.

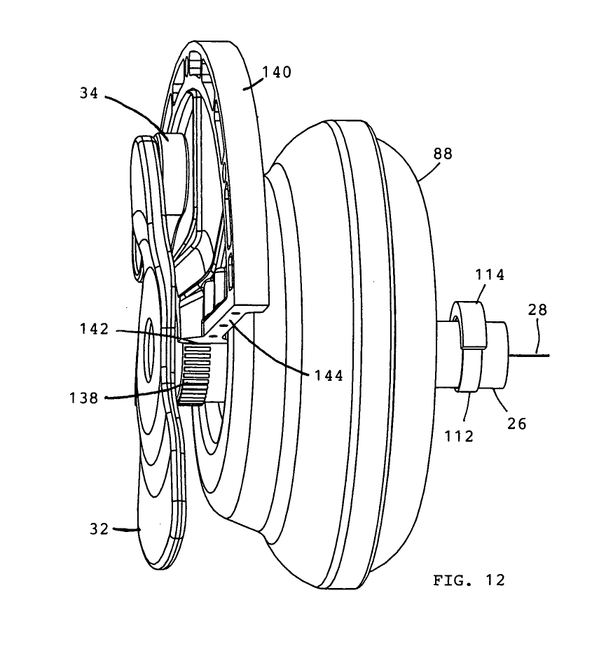

Referring now to FIG. 12, optionally, according to the present invention, the power take-off coupling has a first bearing 112 for rotatably supporting output shaft 26 on second axis of rotation 28, and a first bearing support 114 for supporting first bearing 112, and first bearing support 114 has a generally fixed location relative to crankcase 8 and in general the variable compression ratio engine. The power take-off coupling further has a second bearing 138 for rotatably supporting output shaft 26, and a second bearing support 140 for supporting second bearing 138, second bearing support 140 having a generally fixed location relative to first bearing support 114. Second bearing support 140 has a central bearing socket 142 and a parting line 144, parting line 144 passing through central bearing socket 142 for permitting assembly of second bearing support 140 around second bearing 138. Second bearing 138 may be a journal bearing, as shown in FIGS. 9, 10 and 11, or a roller bearing as shown in FIG. 12. Similarly, first bearing 112 may be a journal bearing or a roller bearing.

Referring now to FIGS. 9, 10 and 11, preferably driven arm 32 is assembled onto output shaft 26 by first: Passing hub 126 through one side of second bearing support 118, and/or passing hub mount 148 through the other side of second bearing support 118, and second: Fastening driven arm 32 to output shaft 26. Bearing support 118 cannot be removed from output shaft 26 after driven arm 32 is fastened to output shaft 26.

The power take-off coupling of the present invention may be employed in machines other than engines, and more specifically the present invention may be used for coupling two misaligned drive shafts. Accordingly, in general terms the drive coupling for misaligned shafts of the present invention includes a first shaft, the first shaft defining a first axis of rotation about which the first shaft rotates, and a second shaft, the second shaft defining a second axis of rotation about which the second shaft rotates. The first shaft further has a drive arm and the second shaft further has a driven arm. The drive coupling also has a linkage, the linkage has a first linkage end and a second linkage end.

The first linkage end is pivotally connected to the drive arm and the second linkage end is pivotally connected to the driven arm for rotatably coupling the first shaft and the second shaft for transferring torque from the first shaft to the second shaft.

Preferably, according to the present invention the drive coupling for misaligned shafts includes no more than one linkage. Preferably the linkage is generally rigid for providing a generally fixed spacing between said first linkage end and said second linkage end. Preferably the first axis of rotation is generally parallel to the second axis of rotation, the location of the first axis of rotation being offset from the second axis of rotation.

The power take-off coupling of the present invention is exceptionally robust, reliable and simple. The axels for the linkage are generally larger in diameter than piston pins, and can withstand engine detonation forces as well as other cranktrain bearings can, such as the piston pins, connecting rod big end bearings and crankshaft main bearings.

A further advantage of the present invention is the small magnitude of its friction penalty. Engines that are currently mated to torque converters will require only one new bearing to support the output shaft of the present invention. The one new bearing contributes relatively little to over-all engine friction losses. The linkage axel bearings pivot only a few degrees back and forth in some embodiments of the present invention, and do not substantively increase engine friction losses. Another advantage of the present invention is its short axial length. The short axial length is highly desirable for packaging of the variable compression ratio engine in small engine bays, commonly found in passenger cars.

The power take-off coupling of the present invention is robust and reliable, can withstand detonation forces to the same degree as other cranktrain components, has very low friction losses, has a short axial length, is easy to assemble, and has a low cost.

While the invention has been described in terms of preferred embodiments, those skilled in the art will recognize that the invention can be practiced with modifications within the scope of the claims.

1. A power take-off coupling for variable compression ratio engines including a crankshaft, said crankshaft defining a first axis of rotation about which said crankshaft rotates, an output shaft, said output shaft defining a second axis of rotation about which said output shaft rotates, said first axis of rotation being generally parallel to said second axis of rotation,
said first axis of rotation further having a location relative to said second axis of rotation, said location of said first axis of rotation being adjustable relative to said second axis of rotation for adjusting the compression ratio of the engine during running operation of the variable compression ratio engine,
said crankshaft further having a drive arm and said output shaft further having a driven arm, and a linkage, said linkage having a first linkage end and a second linkage end,
said first linkage end being pivotally connected to said drive arm and said second linkage end being pivotally connected to driven arm for rotatably coupling said crankshaft and said output shaft for transferring torque from said crankshaft to said output shaft.

2. The power take-off coupling for the variable compression ratio engine of claim 1, wherein said linkage is generally rigid for providing a generally fixed spacing between said first linkage end and said second linkage end.

3. The power take-off coupling for the variable compression ratio engine of claim 1, wherein said power take-off coupling includes no more than one of said linkages.

4. The power take-off coupling for the variable compression ratio engine of claim 1, further including a first linkage axis, said first linkage axis being located in said drive arm, and a second linkage axis, said second linkage axis being located in said driven arm,
said first linkage end being pivotally connected on said first linkage axis to said drive arm, and said second linkage end being pivotally connected to said second linkage axis on said driven arm,
further including a first imaginary line spanning from said first axis of rotation to said first linkage axis, and a second imaginary line spanning from said first linkage axis to said second linkage axis, and a linkage angle, said linkage angle being the angle between said first imaginary line and said second imaginary line,
wherein said linkage angle changes in magnitude by no more than plus or minus 12 degrees during one full rotation of said crankshaft, thereby providing a low friction value for the power take-off coupling, and a small variation in output shaft rotational velocity.

5. The power take-off coupling for the variable compression ratio engine of claim 1, wherein said drive arm is rigid, and said drive arm is rigidly attached to said crankshaft.

6. The power take-off coupling for the variable compression ratio engine of claim 1, wherein said drive arm is rigid, and formed in said crankshaft.

7. The power take-off coupling for the variable compression ratio engine of claim 1, wherein said driven arm is rigid, and said driven arm is rigidly attached to said output shaft.

8. The power take-off coupling for the variable compression ratio engine of claim 1, further including a first linkage axel, said drive arm including said first linkage axel.

9. The power take-off coupling for the variable compression ratio engine of claim 8, wherein said first linkage axel is cantilevered off of said drive arm, thereby permitting said linkage to slide onto the free end of the first linkage axel during assembly.

10. The power take-off coupling for the variable compression ratio engine of claim 9, wherein said first linkage axel is formed directly in said crankshaft.

11. The power take-off coupling for the variable compression ratio engine of claim 1, further including a second linkage axel, said second linkage axel being formed in said driven arm.

12. The power take-off coupling for the variable compression ratio engine of claim 11, wherein said second linkage axel and said driven arm are a single metal part.

13. The power take-off coupling for the variable compression ratio engine of claim 11, wherein said second linkage axel is cantilevered off of said driven arm, thereby permitting said linkage to slide onto the free end of the second linkage axel during assembly,
further including a first linkage axel, said first linkage axel being formed on said drive arm, said first link axel being cantilevered off of said drive arm, and,
said first linkage axel and said second linkage axel further being cantilevered in the same direction, thereby permitting said linkage to slide onto said first linkage axel and said second linkage axel during assembly.

14. The power take-off coupling for the variable compression ratio engine of claim 1, wherein said linkage has female bearing sockets at both ends.

15. The power take-off coupling for the variable compression ratio engine of claim 1, wherein said drive arm includes a drive hub region, and said driven arm includes a driven hub region,
said power take-off coupling further including a radial plane, said linkage being located generally on said radial plain,
wherein said driven arm further includes a bend for alignment of said first linkage end and said second linkage end generally on said radial plan.

16. The power take-off coupling for the variable compression ratio engine of claim 1, wherein said drive arm includes a drive hub region, and said driven arm includes a driven hub region,
said power take-off coupling further including a radial plane, said linkage being located generally on said radial plain,
wherein said drive arm further includes a bend for alignment of said first linkage end and said second linkage end generally on said radial plan.

17. The power take-off coupling for the variable compression ratio engine of claim 11, wherein said second linkage axel is cantilevered off of said driven arm, thereby permitting said linkage to slide onto the free end of the second linkage axel,
further including a first linkage axel, said first linkage axel being formed on said drive arm, said first linkage axel being cantilevered off of said drive arm, said first link axel and said second link axel further being cantilevered in opposite directions, thereby retaining said linkage in place after assembly.

18. The power take-off coupling for the variable compression ratio engine of claim 1, wherein said drive arm includes one or more holes for retaining an axel.

19. The power take-off coupling for the variable compression ratio engine of claim 1, wherein said driven arm includes one or more holes for retaining an axel.

20. The power take-off coupling for the variable compression ratio engine of claim 19, wherein said linkage further includes at least one link, said link being rigidly joined to said axel and said axel being pivotally supported in said driven arm.

21. The power take-off coupling for the variable compression ratio engine of claim 1, further including at least one balance weight for balancing the centrifugal force of said linkage assembly.

22. The power take-off coupling for the variable compression ratio engine of claim 1, further including an end connecting rod journal located generally at the end of the crankshaft adjacent to the power take-off coupling, wherein said first linkage axis is located generally opposite to said end connecting rod journal for minimizing the balancing mass needed for providing a balanced cranktrain.

23. The power take-off coupling for the variable compression ratio engine of claim 1, wherein said driven arm further has a hub, said hub having a hub outer surface, and said power take-off coupling further having a second bearing for supporting said output shaft,
wherein said hub outer surface is the bearing surface for said second bearing.

24. The power take-off coupling for the variable compression ratio engine of claim 1, wherein said output shaft includes a torque converter.

25. The power take-off coupling for the variable compression ratio engine of claim 24, further having a first bearing for rotatably supporting said output shaft on said second axis of rotation, and a first bearing support for supporting said first bearing, said first bearing support having a generally fixed location relative to said variable compression ratio engine,
and a second bearing for rotatably supporting said output shaft, and a second bearing support for supporting said second bearing, said second bearing support having a generally fixed location relative to said first bearing support,
wherein said second bearing support is located generally between said torque converter and said linkage.

26. The power take-off coupling for the variable compression ratio engine of claim 25, further including an oil seal for preventing oil from said second bearing from escaping to the torque converter side of the second bearing support.

27. The power take-off coupling for the variable compression ratio engine of claim 1, further having a first bearing for rotatably supporting said output shaft on said second axis of rotation, and a first bearing support for supporting said first bearing, said first bearing support having a generally fixed location relative to said variable compression ratio engine,
and a second bearing for rotatably supporting said output shaft, and a second bearing support for supporting said second bearing, said second bearing support having a generally fixed location relative to said first bearing support,
wherein said second bearing support has a central bearing socket, said central bearing socket being non separable, wherein said driven arm is attached to said output shaft through said central bearing socket.

28. The power take-off coupling for the variable compression ratio engine of claim 1, wherein said driven arm is rigidly attached to said output shaft by a fixture element selected from the following group: a spline, an interference fit, a key, a weld, or one or more fasteners.

29. The power take-off coupling for the variable compression ratio engine of claim 1, wherein said drive arm is rigidly attached to said crankshaft by a fixture element selected from the following group: a spline, an interference fit, a key, a weld, or one or more fasteners.

30. The power take-off coupling for the variable compression ratio engine of claim 1, further having a first bearing for rotatably supporting said output shaft on said second axis of rotation, and a first bearing support for supporting said first bearing, said first bearing support having a generally fixed location relative to said variable compression ratio engine,
and a second bearing for rotatably supporting said output shaft, and a second bearing support for supporting said second bearing, said second bearing support having a generally fixed location relative to said first bearing support,
wherein said second bearing support has a central bearing socket and a parting line, said parting line passing through said central bearing socket thereby permitting assembly of said bearing support around said second bearing.

31. A drive coupling for misaligned shafts including a first shaft, said first shaft defining a first axis of rotation about which said first shaft rotates, a second shaft, said second shaft defining a second axis of rotation about which said second shaft rotates,
said first shaft further having a drive arm and said second shaft further having a driven arm, and a linkage, said linkage having a first linkage end and a second linkage end,
said first linkage end being pivotally connected to said drive arm and said second linkage end being pivotally connected to said driven arm for rotatably coupling said first shaft and said second shaft for transferring torque from said first shaft to said second shaft.

32. The drive coupling for misaligned shafts of claim 31, wherein said drive coupling includes no more than one of said linkages.

33. The drive coupling for misaligned shafts of claim 31, wherein said linkage is generally rigid for providing a generally fixed spacing between said first linkage end and said second linkage end.

34. The power take-off coupling for the variable compression ratio engine of claim 31, wherein said first linkage end includes a spherical joint.

35. The drive coupling for misaligned shafts of claim 31, wherein said first axis of rotation is generally parallel to said second axis of rotation, the location of said first axis of rotation being offset from said second axis of rotation.
